(19) United States
(12) Patent Application Publication
(10) Pub. No.: US 2022/0048221 A1
(43) Pub. Date: Feb. 17, 2022

(54) AIR ACTIVATING AND AIR COOLING MOLD DEVICE

(71) Applicant: TRUE TEN INDUSTRIAL CO., LTD., Taichung City (TW)

(72) Inventor: Shun-Tsung LU, Taichung City (TW)

(21) Appl. No.: 16/990,732

(22) Filed: Aug. 11, 2020

(51) Int. Cl. B29C 33/04; B29C 45/73

(52) U.S. Cl. CPC B29C 33/046; B29C 2045/735; B29C 2045/7318; B29C 45/7337

(57) ABSTRACT

An air activating and air cooling mold device utilized to process a workpiece includes a mold and an intake device. The mold has at least one gas channel disposed therein, and each of the at least one gas channel has an inlet and at least one outlet. The inlet is disposed on an outer surface of the mold. The at least one outlet is disposed on the outer surface of the mold, is spaced apart from the inlet, and communicates with the inlet. The workpiece is disposed on the mold and covers the at least one outlet. The intake device is mounted to the inlet of the at least one gas channel of the mold, such that gas is injected into the mold via the inlet and flows out of the mold via the at least one outlet.

### BACKGROUND OF THE INVENTION

### 1. Field of the Invention

The present invention relates to a mold device, and more particularly to an air activating and air cooling mold device that heats and activates a workpiece or cools and shapes a workpiece at high efficiency.

### 2. Description of Related Art

A conventional cold shaping method for a workpiece such as a vamp is to sleeve the workpiece on a mold having an evaporator assembly inserted within. The evaporator assembly includes an evaporator and a copper sleeve. The evaporator has a pipe disposed therein to allow refrigerant to flow within. The copper sleeve is sleeved around the evaporator, such that the copper sleeve can be cooled by the evaporator and the copper sleeve can cool down the mold by heat conduction. In such a manner, the cooled-down mold can cool and shape the workpiece.

A conventional heat activation method for a workpiece such as a vamp is to sleeve the workpiece on a mold having a heating tube buried within. By heating the heating tube, the mold can be heated by heat conduction. The heated mold can heat and activate the workpiece thereby.

The mold having the evaporator assembly inserted within applied to the conventional cold shaping method and the mold having the heating tube buried within applied to the heat activation method both change the temperature of the mold by heat conduction. Then the workpiece is heated or cooled down by heat conduction between the workpiece and the mold.

However, the efficiency of heating/cooling and activating/shaping the workpiece by heat conduction is low.

To overcome the shortcomings of the mold having the evaporator assembly inserted within and the mold having the heating tube buried within, the present invention tends to provide an air activating and air cooling mold device to mitigate or obviate the aforementioned problems.

### SUMMARY OF THE INVENTION

The main objective of the present invention is to provide an air activating and air cooling mold device.

The air activating and air cooling mold device is utilized to process a workpiece and includes a mold and an intake device. The mold has at least one gas channel disposed therein, and each of the at least one gas channel has an inlet and at least one outlet. The inlet is disposed on an outer surface of the mold. The at least one outlet is disposed on the outer surface of the mold, is spaced apart from the inlet, and communicates with the inlet. The workpiece is disposed on the mold and the workpiece covers the at least one outlet. The intake device is mounted to the inlet of the at least one gas channel of the mold, such that gas is injected into the mold via the inlet of the at least one gas channel and flows out of the mold via the at least one outlet of the at least one gas channel.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a first embodiment of a mold of an air activating and air cooling mold device in accordance with the present invention;

FIG. 2 is a side view of the air activating and air cooling mold device, showing the mold in FIG. 1 assembled with an intake device for heat activation;

FIG. 3 is an exploded side view of the air activating and air cooling mold device, showing the mold in FIG. 1 disassembled from the intake device for heat activation;

FIG. 4 is an operational side view in partial section of the air activating and air cooling mold device, showing the operational state of the mold in FIG. 1 assembled with the intake device for heat activation;

FIG. 5 is a side view of the air activating and air cooling mold device, showing the mold in FIG. 1 assembled with an intake device for cold shaping;

FIG. 6 is an exploded side view of the air activating and air cooling mold device, showing the mold in FIG. 1 disassembled from the intake device for cold shaping;

FIG. 7 is an operational side view in partial section of the air activating and air cooling mold device, showing the operational state of the mold in FIG. 1 assembled with the intake device for cold shaping;

FIG. 8 is a perspective view of a second embodiment of a mold of an air activating and air cooling mold device in accordance with the present invention;

FIG. 9 is an operational top view in partial section of the air activating and air cooling mold device, showing the operational state of the mold in FIG. 8 assembled with the intake device for heat activation; and

FIG. 10 is an operational top view in partial section of the air activating and air cooling mold device, showing the operational state of the mold in FIG. 8 assembled with the intake device for cold shaping.

### DETAILED DESCRIPTION OF THE PREFERRED EMBODIMENT

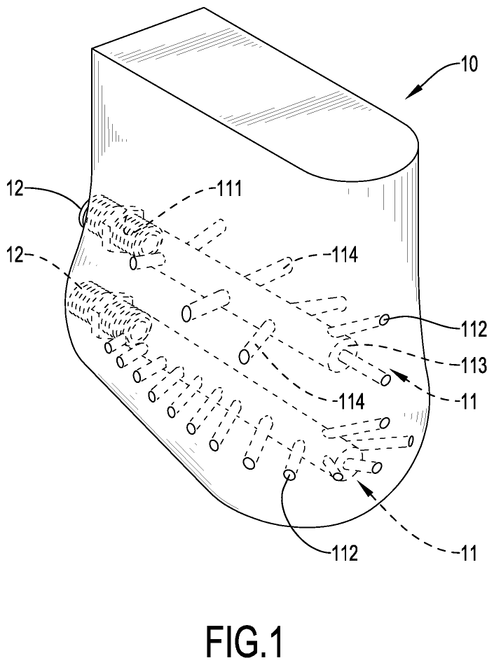

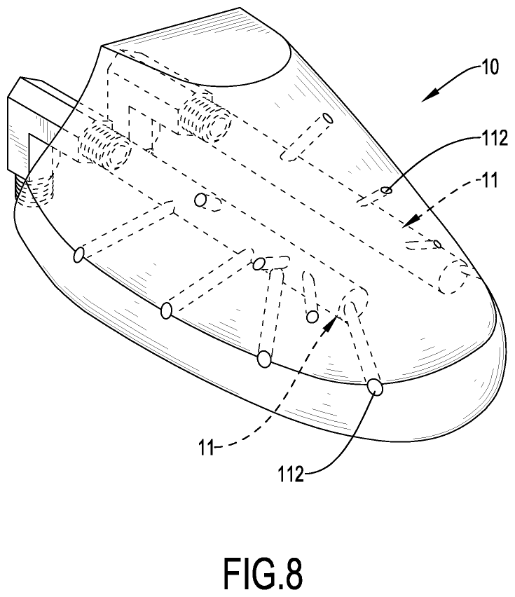

With reference to FIGS. 1, 2, 5, and 7, an air activating and air cooling mold device in accordance with the present invention includes a mold 10 and an intake device 20A, 20B. The mold 10 has at least one gas channel 11 disposed therein. The at least one gas channel 11 has an inlet 111 and at least one outlet 112. The inlet 111 is disposed on an outer surface of the mold 10. The at least one outlet 112 is disposed on the outer surface of the mold 10, is spaced apart from the inlet 111, and communicates with the inlet 111. The intake device 20A, 20B is mounted to the inlet 111 of the at least one gas channel 11 of the mold 10, such that gas can be injected into the mold 10 via the inlet 111 and flow out of the mold 10 via the at least one outlet 112. The mold 10 may be a heel counter mold as shown in FIG. 1, a toe cap mold as shown in FIG. 8, or any other mold utilized to manufacture leatherware such as gloves.

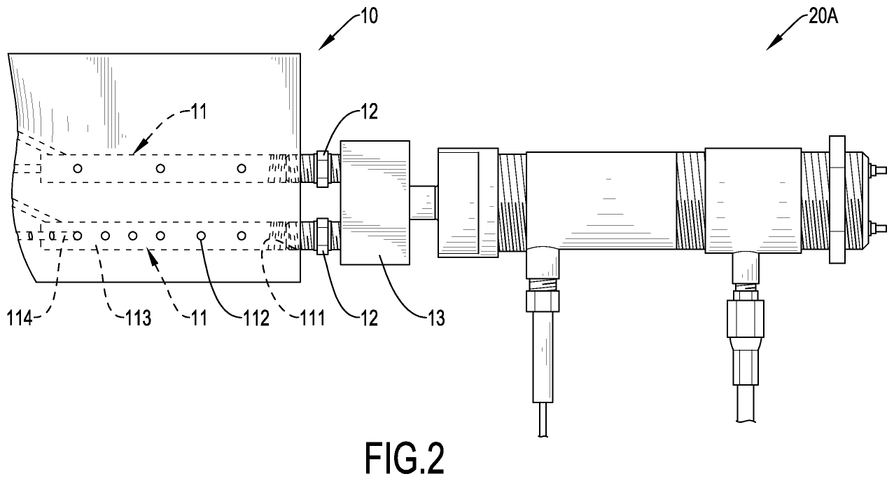

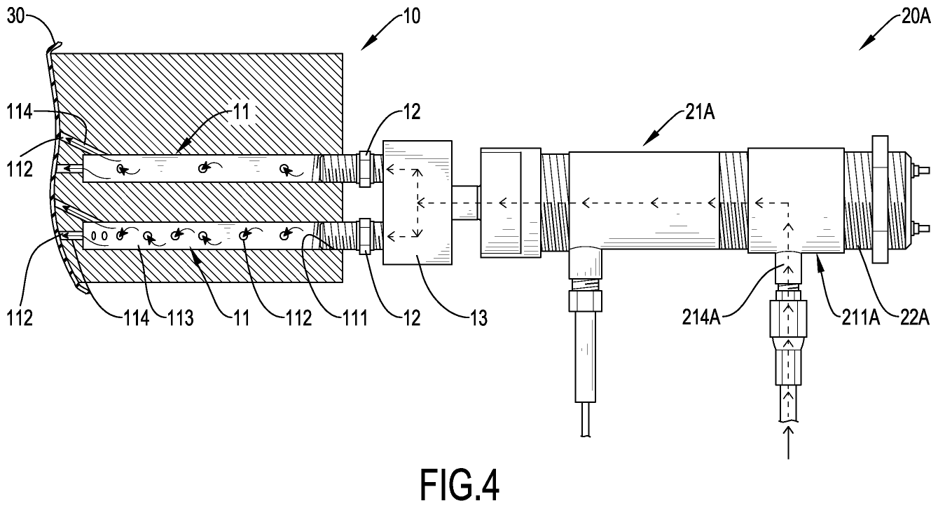

With reference to FIGS. 1 and 4, in a first embodiment of the present invention, the air activating and air cooling mold device includes the mold 10 being the heel counter mold, and the mold 10 has two said gas channels 11, two jointing elements 12, and a diverter valve 13. With reference to FIGS. 1 and 2, the two gas channels 11 are disposed in the mold 10 at a spaced interval along a vertical direction of the mold 10, and each one of the two gas channels 11 has said inlet 111, a main section 113, multiple separation sections 114, and multiple said outlets 112. The main section 113 is formed in the mold 10 and communicates with the inlet 111 of the gas channel 11. The multiple separation sections 114 are formed in and distributed in the mold 10. One of two ends of each one of the multiple separation sections 114 communicates with the main section 113, and an inner diameter of each one of the multiple separation sections 114 is smaller than an inner diameter of the main section 113. Each one of the multiple outlets 112 communicates with a respective one of the multiple separation sections 114, and the multiple outlets 112 are disposed on the outer surface of the mold 10 at spaced intervals.

Each one of the two joint elements 12 is mounted to the inlet 111 of a respective one of the two gas channels 11 and communicates with the inlet 111. Furthermore, the mold 10 has a covered surface defined around the outer surface of the mold 10 except for a top surface of the mold 10, a bottom surface of the mold 10, and a side surface of the mold 10 that the two joint elements 12 are mounted on. The multiple outlets 112 are surroundingly arranged on the covered surface of the mold 10 at spaced intervals, such that the gas flows out of the mold 10 by diffusion. The diverter valve 13 is mounted to the two joint elements 12 and communicates with each one of the two joint elements 12.

With reference to FIGS. 2 to 4, when the mold 10 is utilized in cooperation with the intake device 20A for heat activation, the intake device 20A injects the gas into the inlet 111 of each one of the two gas channels 11 of the mold 10 via the diverter valve 13 and the two jointing elements 12. In such an arrangement, the gas flows out of the mold 10 via the multiple outlets 112 of each one of the two gas channels 11 of the mold 10 to heat and activate a workpiece 30 sleeved on the covered surface of the mold 10 and covering the multiple outlets 112 of each one of the two gas channels 11 as shown in FIG. 4.

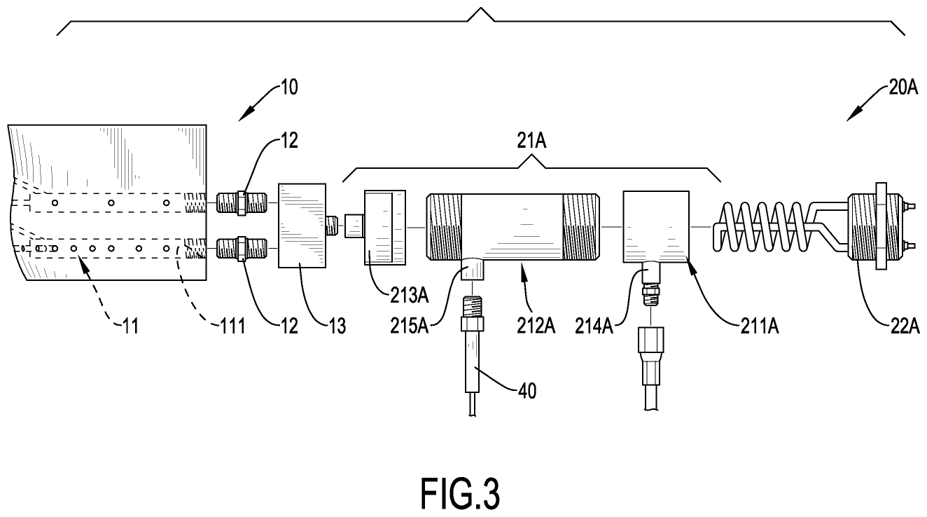

With reference to FIG. 3, the intake device 20A has a body 21A and a heating tube 22A. The body 21A has an intake section 211A, a linking section 212A, and a discharge section 213A. The intake section 211A has an injection tube 214A, and the injection tube 214A protrudes on an outer surface of the intake section 211A and communicates with an interior of the intake section 211A. The injection tube 214A has an injection hole formed therein, such that the gas flows into the injection hole, the injection tube 214, and the intake section 211A sequentially. One of two ends of the linking section 212A is mounted to one of two ends of the intake section 211A, and the linking section 212A communicates with the intake section 211A. The linking section 212A has a connection tube 215 protruding on an outer surface of the linking section 212A and communicates with an interior of the linking section 212A. The connection tube 215 is mounted to a temperature probe 40 capable of sensing the temperature of the gas flowing through the linking section 212A. The discharge section 213A is mounted to one of the two ends of the linking section 212A away from the intake section 211A and communicates with the linking section 212A. One of two ends of the discharge section 213A away from the linking section 212A is mounted to the diverter valve 13 of the mold 10 and communicates with the diverter valve 13.

With reference to FIGS. 2 and 3, the heating tube 22A is mounted to the intake section 211A of the body 21A and extends into the body 21A. After the gas is injected into the body 21A via the injection hole of the injection tube 214A of the intake section 211A, the gas is heated by the heating tube 22A. Then the gas flows via the diverter valve 13 and the two jointing elements 12 and is injected into the inlet 111 of each one of the two gas channels 11 of the mold 10.

Moreover, the heating tube 22A may be buried in the mold 10. The structure that enables the gas to be injected into the inlet 111 and flows out of the mold 10 via the multiple outlets 112 and ejected to the workpiece 30 is what the present invention is aiming to protect.

With reference to FIGS. 1, 3, and 4, to use the first embodiment of the air activating and air cooling mold device in accordance with the present invention in cooperation with the intake device 20A for heat activation, mount the discharge section 213A of the body 21A to the diverter valve 13 and heat the heating tube 22A. Next, inject the gas into the injection hole of the injection tube 214A, and then the gas flows into the injection tube 214 and the intake section 211A sequentially. After the gas flows into the body 21A, the gas is heated by the heating tube 22A and the temperature of the gas rises. The heated gas diverges when flowing through the diverter valve 13 and in turn flows into the two gas channels 11 via the two joint elements 12. In each one of the two gas channels 11, the heated gas flows from the main section 113 to each one of the multiple separation sections 114. Finally, the heated gas flows out of each one of the multiple outlets 112 from the respective one of the multiple separation sections 114 and is ejected to the workpiece 30. In such a manner, the workpiece 30 can be heated and activated.

With reference to FIG. 4, in the present invention, when the heated gas diverges and flows into the multiple separation sections 114 via the main section 113 of each one of the two gas channels 11, the structure that the inner diameter of each one of the multiple separation sections 114 is smaller than the inner diameter of the main section 113 prevents the circumstance that the pressure of the heated gas decreases after flowing out of each one of the multiple outlets 112. Therefore, the ejection effect of the present invention is ensured. By having the two gas channels 11 disposed in the mold 10 at a spaced interval along the vertical direction, the heated gas flows out of the mold 10 evenly and is ejected to all parts of the workpiece 30. Since the multiple outlets 112 are surroundingly arranged on the covered surface of the mold 10 at spaced intervals, the heated gas flows out of the mold 10 by diffusion evenly and is ejected to all parts of the workpiece 30. In such an arrangement, the degree of activation on all parts of the workpiece 30 is even.

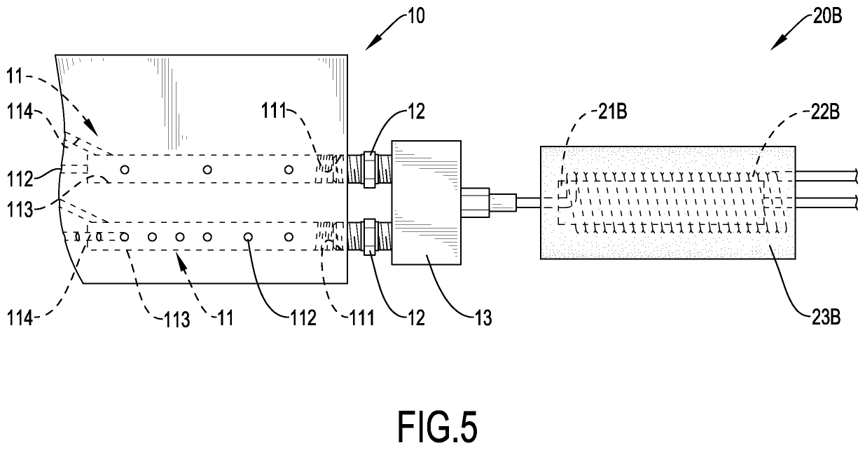

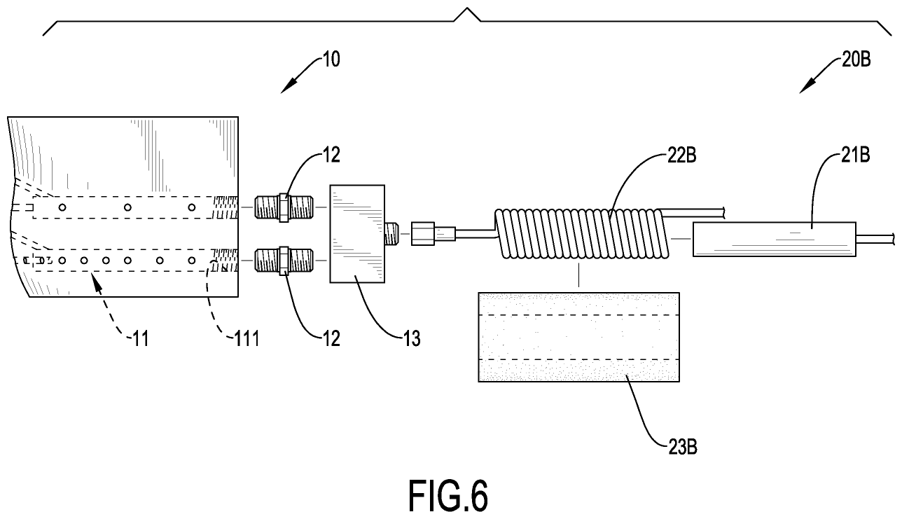

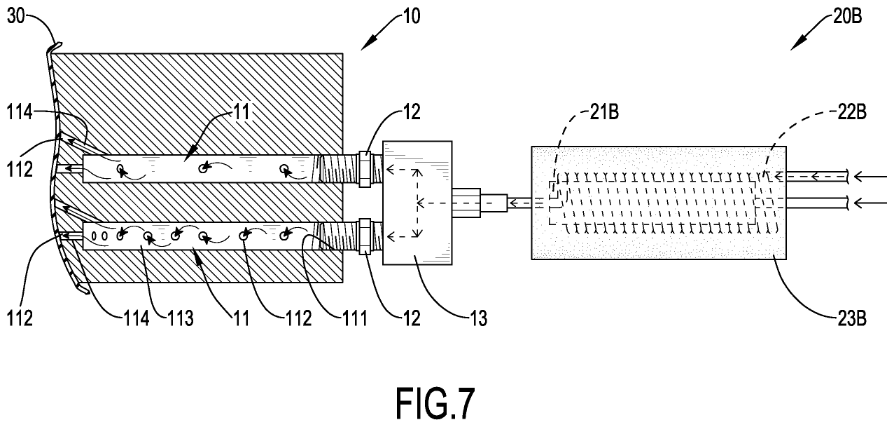

With reference to FIGS. 5 to 7, when the mold 10 is utilized in cooperation with the intake device 20B for cold shaping, the intake device 20B injects the gas into the inlet 111 of each one of the two gas channels 11 of the mold 10 via the diverter valve 13 and the two jointing elements 12. In such an arrangement, the gas flows out of the mold 10 via the multiple outlets 112 of each one of the two gas channels 11 of the mold 10 to cool and shape the workpiece 30 sleeved on the covered surface of the mold 10 and covering the multiple outlets 112 of each one of the two gas channels 11 as shown in FIG. 7. The intake device 20B has a refrigerant pipe 21B, an intake pipe 22B, and an insulation sleeve 23B. The refrigerant pipe 21B allows refrigerant to flow within. The intake pipe 22B is spiral-shaped and surrounds the refrigerant pipe 21B. One of two ends of the intake pipe 22B can be injected with the gas, and the other one of the two ends of the intake pipe 22B is connected to the diverter valve 13 of the mold 10 and communicates with the diverter valve 13. When the gas is flowing within the intake pipe 22B, the gas is cooled by the refrigerant pipe 21B with the refrigerant flowing within. A user can adjust the number of turns on the spiral-shaped intake pipe 22B according to the temperature that the gas should be lowered at. The higher the number of turns on the spiral-shaped intake pipe 22B, the lower the temperature of the gas. The insulation sleeve 23B is sleeved around the intake pipe 22B.

With reference to FIGS. 1 and 7, to use the first embodiment of the air activating and air cooling mold device in accordance with the present invention in cooperation with the intake device 20B for cold shaping, mount the intake pipe 22B to the diverter valve 13 and inject the refrigerant into the refrigerant pipe 21B. Next, inject the gas into one of the two ends of the intake pipe 22B away from the diverter valve 13. The gas is gradually cooled while flowing in the intake pipe 22B. The cooled gas diverges when flowing through the diverter valve 13 and in turn flows into the two gas channels 11 via the two joint elements 12. Finally, the cooled gas flows out of each one of the multiple outlets 112 from the respective one of the multiple separation sections 114 and is ejected to the workpiece 30. In such a manner, the workpiece 30 can be cooled and shaped. The structure of the mold 10, i.e. the two gas channels 11 disposed in the mold 10 at a spaced interval and the multiple outlets 112 surroundingly arranged on the covered surface of the mold 10 at spaced intervals, enables the cooled gas to flow out of the mold 10 by diffusion evenly and be ejected to all parts of the workpiece 30. In such an arrangement, the workpiece 30 can be shaped evenly.

Moreover, since the multiple separation sections 114 of each one of the two gas channels 11 are distributed in the mold 10, the cooled gas also cools down the mold 10 evenly while flowing in the multiple separation sections 114. Therefore, the workpiece 30 sleeved on the covered surface of the mold 10 can also be cooled and shaped by heat conduction between the workpiece 30 and the mold 10 in addition to being cooled and shaped by ejection of the cooled gas.

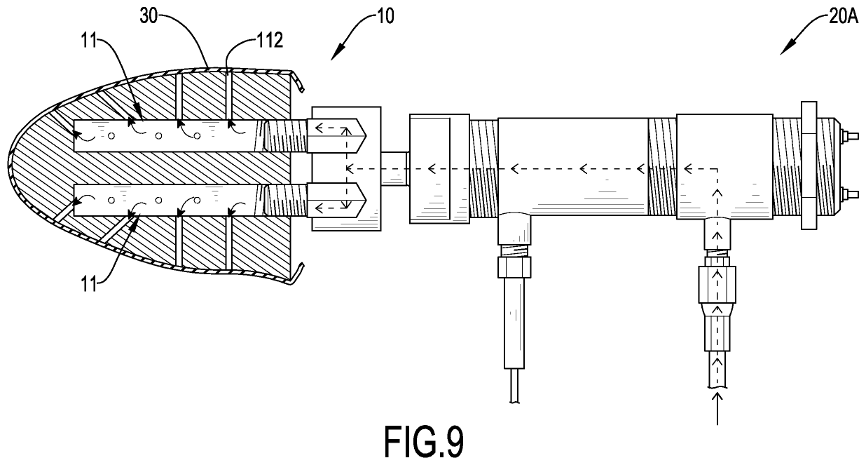

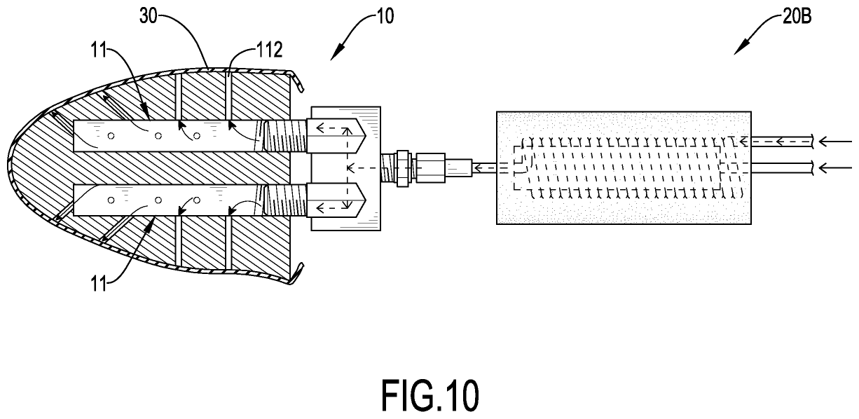

With reference to FIGS. 8 to 10, a second embodiment of the air activating and air cooling mold device in accordance with the present invention includes the mold 10 being the toe cap mold. The difference between the second embodiment and the first embodiment is that: the two gas channels 11 are disposed in the mold 10 at a spaced interval along a horizontal direction of the mold 10, and the multiple outlets 112 of the two gas channels 11 are arranged at spaced intervals on two opposite sides of the covered surface of the mold 10. In such a configuration, the gas flows out of the mold 10 by diffusion.

When in use, cover the workpiece 30 on the multiple outlets 112 of each one of the two gas channels 11 of the mold 10. The method and effect of using the second embodiment of the air activating and air cooling mold device in accordance with the present invention in cooperation with the intake device 20A for heat activation is same as the method and effect of using the first embodiment of the air activating and air cooling mold device in accordance with the present invention in cooperation with the intake device 20A for heat activation. The method and effect of using the second embodiment of the air activating and air cooling mold device in accordance with the present invention in cooperation with the intake device 20B for cold shaping is same as the method and effect of using the first embodiment of the air activating and air cooling mold device in accordance with the present invention in cooperation with the intake device 20B for cold shaping.

With the aforementioned technical characteristics of the present invention, the air activating and air cooling mold device has the following advantages.

1. The mold 10 in accordance with the present invention is utilized in cooperation with the intake device 20A for heat activation or the intake device 20B for cold shaping, such that the gas is injected into the mold 10 via the inlet 111 of the at least one gas channel 11 and flows out of the mold 10 via the at least one outlet 112 of the at least one gas channel 11 to eject to the workpiece 30. Compared with the mold having the evaporator assembly inserted within and the mold having the heating tube buried within that heats and activates the workpiece and cools and shapes the workpiece by heat conduction at low efficiency, the present invention allows the heated gas or the cooled gas to flow through the at least one gas channel 11 disposed in the mold 10 to eject to the workpiece 30 directly. In such a manner, the efficiency of heat activation for a workpiece 30 and the efficiency of cold shaping for a workpiece 30 are both enhanced.

2. Since the multiple separation sections 114 of each one of the two gas channels 11 are distributed in the mold 10, the heated gas and the cooled gas also heat or cool down the mold 10 evenly while flowing in the multiple separation sections 114. Then the mold 10 can also heat or cool the workpiece 30 by heat conduction. Therefore, in addition to having the heated gas or the cooled gas ejected to the workpiece 30 directly, the mold 10 in the present invention is also capable of heating and cooling the workpiece 30 at higher efficiency than that of the mold having the evaporator assembly inserted within and the mold having the heating tube buried within.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. An air activating and air cooling mold device utilized to process a workpiece comprising:
a mold having
at least one gas channel disposed therein, and each of the at least one gas channel having
an inlet disposed on an outer surface of the mold; and
at least one outlet disposed on the outer surface of the mold, spaced apart from the inlet, and communicating with the inlet, wherein the workpiece is disposed on the mold and the workpiece covers the at least one outlet; and
an intake device mounted to the inlet of the at least one gas channel of the mold, such that gas is injected into the mold via the inlet of the at least one gas channel and flows out of the mold via the at least one outlet of the at least one gas channel.

2. The air activating and air cooling mold device as claimed in claim 1, wherein the mold is a heel counter mold.

3. The air activating and air cooling mold device as claimed in claim 1, wherein the mold is a toe cap mold.

4. The air activating and air cooling mold device as claimed in claim 1, wherein the intake device injects the gas into the inlet of the at least one gas channel of the mold and the gas flows out of the mold via the at least one outlet of the at least one gas channel of the mold to heat and activate the workpiece.

5. The air activating and air cooling mold device as claimed in claim 2, wherein the intake device injects the gas into the inlet of the at least one gas channel of the mold and the gas flows out of the mold via the at least one outlet of the at least one gas channel of the mold to heat and activate the workpiece.

6. The air activating and air cooling mold device as claimed in claim 3, wherein the intake device injects the gas into the inlet of the at least one gas channel of the mold and the gas flows out of the mold via the at least one outlet of the at least one gas channel of the mold to heat and activate the workpiece.

7. The air activating and air cooling mold device as claimed in claim 4, wherein the intake device has
a body having an injection hole; and
a heating tube mounted to the body;
wherein the gas is injected into the inlet of the at least one gas channel of the mold after being injected into the body via the injection hole and being heated by the heating tube sequentially.

8. The air activating and air cooling mold device as claimed in claim 5, wherein the intake device has
a body having an injection hole; and
a heating tube mounted to the body;
wherein the gas is injected into the inlet of the at least one gas channel of the mold after being injected into the body via the injection hole and being heated by the heating tube sequentially.

9. The air activating and air cooling mold device as claimed in claim 6, wherein the intake device has
a body having an injection hole; and
a heating tube mounted to the body;
wherein the gas is injected into the inlet of the at least one gas channel of the mold after being injected into the body via the injection hole and being heated by the heating tube sequentially.

10. The air activating and air cooling mold device as claimed in claim 1, wherein the intake device injects the gas into the inlet of the at least one gas channel of the mold and the gas flows out of the mold via the at least one outlet of the at least one gas channel of the mold to cool and shape the workpiece.

11. The air activating and air cooling mold device as claimed in claim 2, wherein the intake device injects the gas into the inlet of the at least one gas channel of the mold and the gas flows out of the mold via the at least one outlet of the at least one gas channel of the mold to cool and shape the workpiece.

12. The air activating and air cooling mold device as claimed in claim 3, wherein the intake device injects the gas into the inlet of the at least one gas channel of the mold and the gas flows out of the mold via the at least one outlet of the at least one gas channel of the mold to cool and shape the workpiece.

13. The air activating and air cooling mold device as claimed in claim 10, wherein the intake device has
a refrigerant pipe allowing refrigerant to flow within; and
an intake pipe surrounding the refrigerant pipe;
wherein the gas is cooled by the refrigerant pipe with the refrigerant flowing within while flowing within the intake pipe, and the gas is injected into the inlet of the at least one gas channel of the mold afterwards.

14. The air activating and air cooling mold device as claimed in claim 11, wherein the intake device has
a refrigerant pipe allowing refrigerant to flow within; and
an intake pipe surrounding the refrigerant pipe;
wherein the gas is cooled by the refrigerant pipe with the refrigerant flowing within while flowing within the intake pipe, and the gas is injected into the inlet of the at least one gas channel of the mold afterwards.

15. The air activating and air cooling mold device as claimed in claim 12, wherein the intake device has
a refrigerant pipe allowing refrigerant to flow within; and
an intake pipe surrounding the refrigerant pipe;
wherein the gas is cooled by the refrigerant pipe with the refrigerant flowing within while flowing within the intake pipe, and the gas is injected into the inlet of the at least one gas channel of the mold afterwards.

16. The air activating and air cooling mold device as claimed in claim 1, wherein the at least one gas channel of the mold has multiple said outlets, and the multiple outlets are arranged on the outer surface of the mold at spaced intervals, such that the gas flows out of the mold by diffusion.

17. The air activating and air cooling mold device as claimed in claim 2, wherein the at least one gas channel of the mold has multiple said outlets, and the multiple outlets are arranged on the outer surface of the mold at spaced intervals, such that the gas flows out of the mold by diffusion.

18. The air activating and air cooling mold device as claimed in claim 3, wherein the at least one gas channel of the mold has multiple said outlets, and the multiple outlets are arranged on the outer surface of the mold at spaced intervals, such that the gas flows out of the mold by diffusion.

19. The air activating and air cooling mold device as claimed in claim 1, wherein the at least one gas channel of the mold has
a main section communicating with the inlet;
multiple separation sections, each one of the multiple separation sections communicating with the main section and having
an inner diameter smaller than an inner diameter of the main section; and
multiple said outlets arranged on the outer surface of the mold at spaced intervals, and each one of the multiple outlets communicating with a respective one of the multiple separation sections.

20. The air activating and air cooling mold device as claimed in claim 2, wherein the at least one gas channel of the mold has
a main section communicating with the inlet;
multiple separation sections, each one of the multiple separation sections communicating with the main section and having
an inner diameter smaller than an inner diameter of the main section; and
multiple said outlets arranged on the outer surface of the mold at spaced intervals, and each one of the multiple outlets communicating with a respective one of the multiple separation sections.
